(19) United States
(12) Patent Application Publication
(10) Pub. No.: US 2013/0186548 A1
(43) Pub. Date: Jul. 25, 2013

(54) METHOD FOR PRODUCING LAMINATED FILM

(71) Applicants: Hiroyuki Takao, Ibaraki-shi (JP); Katsunori Takada, Ibaraki-shi (JP); Daigoro Nakagawa, Ibaraki-shi (JP); Hiroki Ozawa, Ibaraki-shi (JP)

(72) Inventors: Hiroyuki Takao, Ibaraki-shi (JP); Katsunori Takada, Ibaraki-shi (JP); Daigoro Nakagawa, Ibaraki-shi (JP); Hiroki Ozawa, Ibaraki-shi (JP)

(73) Assignee: NITTO DENKO CORPORATION, Ibaraki-shi, Osaka (JP)

(21) Appl. No.: 13/877,136

(22) PCT Filed: Sep. 28, 2011
(86) PCT No.: PCT/JP2011/072238

§ 371 Date: Mar. 29, 2013

(30) Foreign Application Priority Data
Sep. 29, 2010 (JP) 2010-219310

(51) Int. Cl. B32B 38/08

(52) U.S. Cl. CPC B32B 38/08
USPC 156/60; 427/385.5

(57) ABSTRACT

A process including (1) applying a solution composition to one or both sides of a first transparent resin film to form a coating layer or layers, wherein the solution composition contains an active energy ray-curable compound, a photopolymerization initiator, and a solvent, wherein the photopolymerization initiator has a 10% weight loss temperature of 170° C. or more as measured by a loss-on-heating test; (2) removing, after the coating step (1), a solvent from the coating layer or layers by drying under such temperature conditions that the first laminated film obtained has a thermal shrinkage of 0.5% or less when heated at 150° C. for 1 hour, and (3) curing the coating layer or layers after the heat-treating step (2). A second laminated film produced with the first laminated film makes it possible to suppress curling and to prevent oligomer precipitation.

### TECHNICAL FIELD

The invention relates to a method for producing a laminated film (first laminated film) including a first heat-shrinkable transparent resin film and a cured layer or layers provided on one or both sides of the first resin film. The first laminated film obtained by the production method is used to form a second laminated film. The second laminated film is formed by laminating a second heat-shrinkable transparent resin film on the cured layer of the first laminated film with a pressure-sensitive adhesive layer interposed therebetween. The second laminated film can be used in various applications such as optical applications.

For example, when the second transparent resin film has a transparent conductive thin layer, the second laminated film can be used as a laminate of transparent conductive film. The transparent conductive film can be used to form a transparent electrode for a display such as a liquid crystal display or an electroluminescence display or for a touch panel such as an optical, ultrasonic, capacitance, or resistive touch panel. In addition, the transparent conductive film can be used for electromagnetic wave shielding or prevention of static buildup on transparent products and to form liquid crystal dimming glass products, transparent heaters, etc.

### BACKGROUND ART

Touch panels produced using a transparent conductive film as an electrode can be classified according to the position sensing method into an optical type, ultrasonic type, a capacitance type, a resistive type, and others. Resistive touch panels are configured to include a transparent conductive film and a transparent conductor-carrying glass plate, which are arranged opposite to each other with spacers interposed therebetween, in which an electric current is allowed to flow through the transparent conductive film, while the voltage at the transparent conductor-carrying glass plate is measured.

Concerning the transparent conductive film, there has been proposed a transparent conductive laminated film including a conductive film having a transparent film substrate and a transparent conductive thin layer provided on one surface of the substrate; and a transparent base material that has a hard coating layer as an outer surface layer and is bonded to the other surface of the transparent film substrate with a pressure-sensitive adhesive layer interposed therebetween so that the laminated film can withstand scratching or taps during pressing operation (Patent Document 1).

When the transparent conductive film is incorporated into an electronic device such as a touch panel, a lead is provided at an end of the transparent conductive layer using a silver paste. For example, such a lead is formed by a method including heating a conductive paste at about 100 to 150° C. for about 1 to 2 hours to cure the paste. Unfortunately, transparent conductive films have a problem in which they can curl when cured by heating, because they are produced using a heat-shrinkable transparent resin film, such as a polyethylene terephthalate film, as a transparent film substrate. In particular, the problem of curling is significant in a transparent conductive laminated film including a laminate having a hard coating layer-carrying transparent substrate. To solve the problem of curing, it is proposed to form a thin hard coating layer or to use a less heat-shrinkable material for the transparent film substrate. In such a case, however, the hard coating layer cannot sufficiently function because of its insufficient hardness or the like.

It is also proposed that a laminate including a transparent substrate and hard coating layers formed on both sides of the substrate should be used to form a transparent conductive laminated film (Patent Documents 2 and 3). This structure can suppress the curling of a transparent conductive laminated film. However, a transparent conductive laminated film with this structure is not preferred in view of a reduction in thickness, because recently, as electronic devices such as touch panels have been reduced in thickness, transparent conductive laminated films have been required to be thinner.

Alternatively, if a heat treatment is previously performed before leads are formed on the transparent conductive laminated film, the curling of the transparent conductive laminated film can be suppressed. However, if a heat treatment is further performed on the transparent conductive laminated film, the number of production processes will increase accordingly, which is not preferred in view of production cost.

On the other hand, when a heat-shrinkable transparent resin film such as a polyethylene terephthalate film is used as a transparent film substrate to form a transparent conductive laminated film, a problem occurs in which low-molecular-weight components (oligomers) in the transparent film substrate is precipitated by heating to whiten the transparent conductive film. To solve this problem, it is proposed to provide an oligomer blocking layer on the transparent film substrate.

### PRIOR ART DOCUMENTS

### Patent Documents

Patent Document 1: JP-B1-2667686

Patent Document 2: JP-A-07-013695

Patent Document 3: JP-A-08-148036

### SUMMARY OF THE INVENTION

### Problems to be Solved by the Invention

It is an object of the invention to provide a simple method for producing a first laminated film, which makes it possible to suppress curling and to prevent oligomer precipitation even when a second laminated film produced with the first laminated film is subjected to a heating process, wherein the first laminated film includes a first transparent resin film and a cured layer and is for used in forming a second laminated film (a laminate including first and second heat-shrinkable transparent resin films laminated on each other with a pressure-sensitive adhesive layer interposed therebetween) such as a transparent conductive laminated film.

It is another object of the invention to provide a method for producing a second laminated film using the first laminated film, which makes it possible to suppress curling and to prevent oligomer precipitation even when a heating process is performed.

### Means for Solving the Problems

In order to solve the problems described above, the inventors have made investigations, as a result, it has been found that the object can be achieved using the method described below so that the invention has been completed.

The invention relates to a method for producing a first laminated film, including:

forming a cured layer or layers on one or both sides of a first heat-shrinkable transparent resin film,

wherein the first laminated film is for use in forming a second laminated film by laminating a second heat-shrinkable transparent resin film on the cured layer of the first laminated film with a pressure-sensitive adhesive layer interposed therebetween,

the cured layer has a thickness of less than 1 μm, and

the cured layer is formed by a process including:

a coating step (1) applying a solution composition to one or both sides of the first transparent resin film to form a coating layer or layers, wherein the solution composition contains an active energy ray-curable compound, a photopolymerization initiator, and a solvent, wherein the photopolymerization initiator has a 10% weight loss temperature of 170° C. or more as measured by a loss-on-heating test;

a heat-treating step (2) removing, after the coating step (1), a solvent from the coating layer or layers by drying under such temperature conditions that the first laminated film obtained has a thermal shrinkage of 0.5% or less when heated at 150° C. for 1 hour, and

a curing step (3) curing the coating layer or layers after the heat-treating step (2).

In the method for producing a first laminated film, the photopolymerization initiator is preferably

2-hydroxy-1-{4-[4-(2-hydroxy-methyl-propionyl)benzyl]phenyl}-2-methyl-propane-1-one and/or
2-methyl-1-(4-methylthiophenyl)-2-morpholinopropane-1-one.

In the method for producing a first laminated film, the photopolymerization initiator is preferably used in an amount of 0.1 parts by weight or more based on 100 parts by weight of the active energy ray-curable compound.

In the method for producing a first laminated film, the heat-treating step (2) can be performed at a temperature of 125 to 165° C.

In the method for producing a first laminated film, the first laminated film may has the cured layer as an outermost layer on one side and has a functional layer as another outermost layer on another side. The functional layer is preferably a hard coating layer.

The invention also relates to a method for producing a second laminated film, including:

producing the first laminated film by the above method; and

then performing a laminating step (4) bonding a second heat-shrinkable transparent resin film to the cured layer of the first laminated film with a pressure-sensitive adhesive layer interposed therebetween.

In the method for producing a second laminated film, a transparent conductive layer is preferably provided, directly with an undercoat layer interposed therebetween, on one side of the second transparent resin film opposite to the second transparent resin film side where the cured layer is to be bonded.

In the method for producing a second laminated film, when the transparent conductive layer is an amorphous transparent conductive layer made of a metal oxide, the method further may include a crystallizing step (5) crystallizing the amorphous transparent conductive layer by heating after the laminating step (4).

### Effect of the Invention

According to the invention, the first laminated film includes a first heat-shrinkable transparent resin film and a cured layer. The cured layer is made from a solution composition containing an active energy ray-curable compound, a polymerization initiator, and a solvent. The cured layer functions as an oligomer blocking layer. Thus, oligomer precipitation can also be prevented in the second laminated film, which is obtained by laminating the second transparent resin film on the cured layer of the first laminated film with the pressure-sensitive adhesive layer interposed therebetween.

The cured layer is formed by a process including performing the coating step (1) to form a coating layer and then subjecting the coating layer to the specified heat-treating step (2). In the heat-treating step (2), the first transparent resin film is also subjected to the heat treatment while the solvent is removed from the coating layer by drying. The heat treatment is performed under such controlled temperature conditions that the first laminated film obtained has a thermal shrinkage of 0.5% or less (in each of the MD (machine direction) and the TD (transverse direction)) when heated at 150° C. for 1 hour. In other words, the first laminated film obtained has already undergone the heat treatment. Thus, even if the first laminated film is subjected to an additional heat treatment, thermal shrinkage will hardly occur, and curling of the first laminated film can be suppressed. Thus, curling of the second laminated film, which is obtained using the first laminated film, can also be suppressed even when the second laminated film is subjected to a heating process. Particularly when the thermal shrinkage of the second transparent resin film for use in the second laminated film is so controlled as to be a similar level to that of the first laminated film (by performing a pre-heat-treatment in such a manner that the thermal shrinkage of the second transparent resin film can be substantially the same as that of the first laminated film), the second laminated film is effectively prevented from curling. In the heat-treating step (2), the solvent is removed by drying, and at the same time, the first laminated film is subjected to the heat treatment. Thus, the production method of the invention is inexpensive and simple because the heat treatment that used to be performed after the production of the first or second laminated film in the conventional process can be omitted.

The temperature conditions for the heat-treating step (2) are such that the first laminated film has a thermal shrinkage of 0.5% or less when heated at 150° C. for 1 hour. Thus, the set temperature conditions are severer than temperature conditions for simply removing the solvent by drying. On the other hand, since the temperature conditions for the heat-treating step (2) are relatively severe, the photopolymerization initiator present in the surface part of the coating layer tends to volatilize in the heat-treating step (2). If the volatilization significantly increases, the reactivity in the curing step (3) for curing the coating layer may be insufficient at the surface part so that a cured layer with poor scratch resistance may be formed. In such a case, the cured layer of the first laminated film can be scratched, for example, when the first laminated film is fed to the process of bonding it to the second transparent resin film, which can cause a defective appearance. In the invention, however, the solution composition used in the coating step (1) contains a photopolymerization initiator that has a 10% weight loss temperature of 170° C. or more as measured by a loss-on-heating test. Such a photopolymerization initiator is significantly less volatile from the surface part of the coating layer, and provides reactivity in the curing step (3) even after the heat-treating step (2), so that a cured layer with a satisfactory level of scratch resistance can be formed. It can be considered that a large amount of a photopolymerization initiator is used so that a certain portion of the photopolymerization initiator volatilized from the surface part of the coating layer can be compensated for. However, if any other photopolymerization initiator than that specified in the invention is used, it will be difficult to form a cured layer with a satisfactory level of scratch resistance, because any other photopolymerization initiator than that specified in the invention is significantly volatilized from the surface part of the coating layer in the heat-treating step (2).

As described above, a cured layer with a satisfactory level of scratch resistance can be formed in the invention. Thus, the cured layer may be formed with a thickness of less than 1 μm, which makes it possible to reduce the thickness of the first laminated film and to reduce the second laminated film, which is produced using the first laminated film.

### BRIEF DESCRIPTION OF THE DRAWINGS

FIG. 1 is a cross-sectional view showing an exemplary embodiment of the first laminated film according to the invention.

FIG. 2A is a cross-sectional view showing an exemplary embodiment of the second laminated film according to the invention.

FIG. 2B is a cross-sectional view showing an exemplary embodiment of the second laminated film according to the invention.

FIG. 3 is a schematic diagram showing an exemplary embodiment of the method of the first laminated film according to the invention.

### MODE FOR CARRYING OUT THE INVENTION

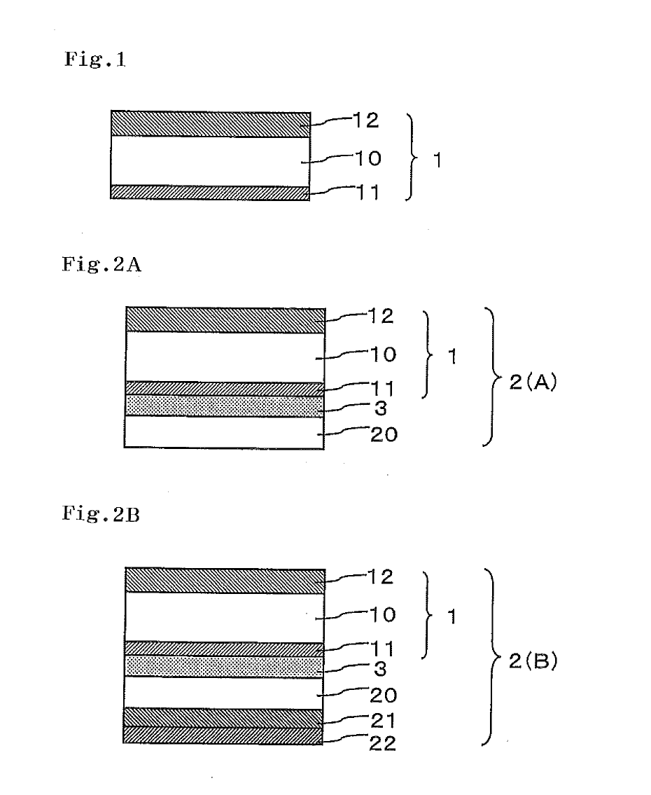

Embodiments of the first and second laminated films according to the invention and the method of the invention for producing thereof are described below with reference to the drawings. FIG. 1 is a cross-sectional view showing an example of the first laminated film 1 according to the invention. FIG. 1 shows a case where the first laminated film 1 includes a first transparent resin film 10 and a cured layer 11 provided on one side of the first transparent resin film 10. Alternatively, the cured layers 11 may be provided on both sides of the first transparent resin film 10. FIG. 1 also shows a case where a functional layer (e.g., a hard coating layer) 12 is provided on one side of the first transparent resin film 10 opposite to the first transparent resin film 10 side where the cured layer 11 is provided. The functional layer may be formed in the first laminated film in such a manner that the first laminated film has the cured layer as an outermost layer on its one side and has the functional layer as another outermost layer on its other side. When the cured layers 11 are formed on both sides of the first transparent resin film 10, the functional layer 12 may be formed on one of the cured layers 11.

FIG. 2 is a cross-sectional view showing an example of the second laminated film 2 according to the invention. FIG. 2A shows a second laminated film 2(A) including the first laminated film 1 shown in FIG. 1, a pressure-sensitive adhesive layer 3, and a second transparent resin film 20 laminated on the cured layer 11 of the first laminated film 1 with the pressure-sensitive adhesive layer 3 interposed therebetween. FIG. 2B shows a second laminated film 2(B) including the laminated film 2(A) shown in FIG. 2A, an undercoat layer 21, and a transparent conductive layer 22 provided on one side of the second transparent resin film 20 opposite to the second transparent resin film 20 side where the cured layer 11 is bonded, wherein the undercoat layer 21 is interposed between the second transparent resin film 20 and the transparent conductive layer 22. The second laminated film 2(B) of FIG. 2B can be used as a transparent conductive film. In FIG. 2B, the transparent conductive layer 22 is provided on the second transparent resin films 20 with the undercoat layer 21 interposed therebetween. Alternatively, the transparent conductive layer 22 may be provided directly on the second transparent resin film 20 without the undercoat layer 21 interposed therebetween.

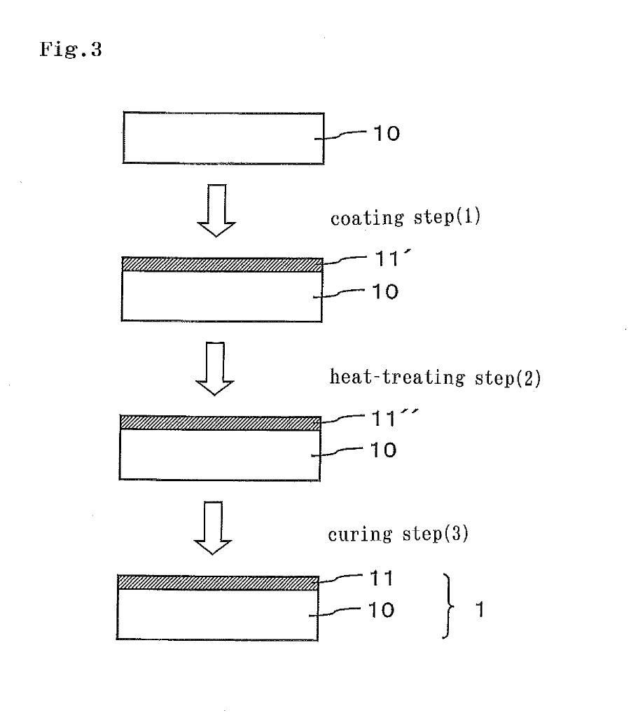

FIG. 3 is a schematic diagram showing an example of the method of the invention for producing the first laminated film. FIG. 3 shows a case where a first laminated film 1 is formed by forming a cured layer 11 on one side of a first transparent resin film 10. Referring to FIG. 3, first, a coating step (1) is performed which includes applying a solution composition to one side of a first transparent resin film 10 to form a coating layer 11′. A heat-treating step (2) is then performed which includes removing the solvent from the coating layer 11′ by drying to form a dried coating layer 11″. The heat-treating step (2) is performed under such temperature conditions that a first laminated film 1 with a specific thermal shrinkage of 0.5% or less can be obtained. A curing step (3) is then performed which includes curing the coating layer 11″ to form a cured layer 11. Although not shown in FIG. 3, a laminating step (4) may be performed which includes laminating a second transparent resin film 20 (or a transparent conductive film including the second transparent resin film and a transparent conductive layer 22 or the like provided thereon) on the cured layer 11 of the resulting first laminated film 1 with a pressure-sensitive adhesive layer 3 interposed therebetween to form the second laminated film 2(A) or 2(B). Although FIG. 3 does not show the step of forming the functional layer 12, the step of forming the functional layer may be performed on the first transparent resin film 10 before the coating step (1) or performed on the resulting first laminated film 1 or second laminated film 2(A) or 2(B).

Although not shown, when the second laminated film 2(B) of FIG. 2B is produced as shown in FIG. 3 and when the transparent conductive layer 22 of the second laminated film 2(B) is an amorphous transparent conductive thin layer made of a metal oxide, the laminating step (4) may be followed by a crystallizing step (5) that includes crystallizing the amorphous transparent conductive thin layer by heating.

First, a description is given of the first laminated film 1 according to the invention. The first laminated film 1 includes a first heat-shrinkable transparent resin film 10 and a cured layer 11.

A plastic film shrinkable by heating at a temperature of about 150° C. for about 1 hour may be used as the first heat-shrinkable transparent resin film 10. For example, the heat-shrinkable resin film may be a film stretched in at least one direction. The stretching process may be any of various stretching processes such as uniaxial stretching, simultaneous biaxial stretching, and sequential biaxial stretching. In view of mechanical strength, the first transparent resin film 10 is preferably a biaxially stretched resin film.

A material of the heat-shrinkable resin film is, but not limited to, various types of plastic material having transparency. Examples of the material for the heat-shrinkable resin film include polyester resins such as polyethylene terephthalate or polybutylene terephthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. Above all, polyester resins polycarbonate resins polyolefin resins, and polyethersulfone are preferred.

Examples thereof also include, as disclosed in JP-A No. 2001 343529 (WO10/37007), a resin composition that contains a thermoplastic resin having a substituted and/or unsubstituted inside group in the side chain and a thermoplastic resin having a substituted and/or unsubstituted phenyl and nitrile groups in the side chain. Specifically, a resin composition containing an alternating copolymer of isobutylene and N-methylmaleimide and an acrylonitrile-styrene copolymer may be used as the materials of the resin films.

The first transparent resin film 10 is generally formed of a monolayer film. In general, the first transparent resin film 10 preferably has a thickness of 30 to 250 μm, more preferably 45 to 200 μm.

The cured layer 11 is formed on one or each side of the first transparent resin film 10. The cured layer 11 has functions such as preventing migration of migrant components in the first transparent resin film 10, typically, migration of low-molecular-weight polyester oligomer components, which are migrant components in a polyester film. The cured layer 11 is made from a solution composition containing an active energy ray-curable compound, a photopolymerization initiator, and a solvent, in which the photopolymerization initiator has a 10% weight loss temperature of 170° C. or more as measured by a loss-on-heating test.

The cured layer 11 has a thickness of less than 1 μm. Even in the heat-treating step (2), the photopolymerization initiator in the solution composition is less volatile from the surface of the coating layer. Thus, a satisfactory level of scratch resistance and an oligomer migration-preventing function can be provided even when a thin cured layer is formed. Even when the cured layer 11 has a thickness of 800 nm or less, specifically, 600 nm or less, the scratch resistance and the function of preventing oligomer migration can be imparted to the cured layer. To impart a sufficient level of scratch resistance and an oligomer migration preventing function to the cured layer 11, the cured layer 11 is preferably formed with a thickness of 120 nm or more.

The active energy ray-curable compound may be a material that has a functional group containing at least one polymerizable double bond in the molecule and is capable of forming a resin layer. The polymerizable double bond-containing functional group may be a vinyl group, a (meth)acryloyl group, or the like. The term “(meth)acryloyl group” means an acryloyl group and/or a methacryloyl group, and “(meth)”, as used herein, has the same meaning.

The active energy ray-curable compound may be an active energy ray-curable resin having the polymerizable double bond-containing functional group. Examples of such a resin include a silicone resin, a polyester resin, a polyether resin, an epoxy resin, a urethane resin, an alkyd resin, a spiroacetal resin, a polybutadiene resin, a polythiolpolyene resin, an oligomer or prepolymer of an acrylate or methacrylate of a polyfunctional compound such as a polyhydric alcohol. These compounds may be used alone or in combination of two or more.

Besides the above active energy ray-curable resin, the active energy ray-curable compound may be a reactive diluent having a functional group containing at least one polymerizable double bond in the molecule. Examples of the reactive diluent include monofunctional (meth)acrylates such as (meth)acrylates of ethylene oxide-modified phenols, (meth)acrylates of propylene oxide-modified phenols, (meth)acrylates of ethylene oxide-modified nonylphenols, (meth)acrylates of propylene oxide-modified nonylphenols, 2-ethylhexylcarbitol (meth)acrylate, isobornyl (meth)acrylate, tetrahydrofurfuryl (meth)acrylate, hydroxyethyl (meth)acrylate, hydroxypropyl (meth)acrylate, hydroxybutyl (meth)acrylate, hydroxyhexyl (meth)acrylate, diethylene glycol mono(meth)acrylate, triethylene glycol mono(meth)acrylate, and tripropylene glycol mono(meth)acrylate. Examples of the reactive diluent also include bifunctional, trifunctional, and polyfunctional (meth)acrylates such as diethylene glycol di(meth)acrylate, triethylene glycol di(meth)acrylate, dipropylene glycol di(meth)acrylate, tripropylene glycol di(meth)acrylate, tetrapropylene glycol di(meth)acrylate, polypropylene glycol di(meth)acrylate, 1,4-butanediol di(meth)acrylate, neopentyl glycol di(meth)acrylate, 1,6-hexanediol di(meth)acrylate, di(meth)acrylate of ethylene oxide-modified neopentyl glycol, di(meth)acrylate of ethylene oxide-modified bisphenol A, di(meth)acrylate of propylene oxide-modified bisphenol A, di(meth)acrylate of ethylene oxide-modified hydrogenated bisphenol A, trimethylolpropane di(meth)acrylate, trimethylolpropane allyl ether di(meth)acrylate, trimethylolpropane tri(meth)acrylate, ethylene oxide-modified trimethylolpropane tri(meth)acrylate, propylene oxide-modified trimethylolpropane tri(meth)acrylate, pentaerythritol tetra(meth)acrylate, dipentaerythritol tetra(meth)acrylate, and dipentaerythritol hexa(meth)acrylate. Other examples include butanediol glycerine ether di(meth)acrylate and (meth)acrylate of isocyanuric acid. The reactive diluents may be used alone or in combination of two or more.

To increase the hardness of the cured layer and to suppress curling, the solution composition used to form the cured layer may also contain an inorganic material (inorganic oxide particles) in addition to the active energy ray-curable compound. Examples of the inorganic oxide particles include fine particles of silicon oxide (silica), titanium oxide, aluminum oxide, zinc oxide, tin oxide, zirconium oxide, mica, etc. Particularly preferred are fine particles of silicon oxide (silica), titanium oxide, aluminum oxide, zinc oxide, tin oxide, and zirconium oxide. These may be used alone or in combination of two or more.

The inorganic oxide particles are preferably nanoparticles with a weight average particle size in the range of 1 nm to 200 nm. The weight average particle size is more preferably in the range of 1 nm to 100 nm. The weight average particle size of the inorganic oxide particles is that of fine particles determined by Coulter counting method. More specifically, a particle size distribution meter (Coulter Multisizer (trade name) manufactured by Beckman Coulter, Inc.) based on pore electric resistance method is used to measure the electric resistance of an electrolytic solution, which corresponds to the volume of fine particles passing through pores, so that the number and volume of the fine particles are determined, and the weight average particle size is calculated from the number and volume of the fine particles.

The inorganic oxide particles used may be bonded to an organic compound containing a polymerizable unsaturated group. The polymerizable unsaturated group is cured by reacting with the active energy ray-curable compound to increase the hardness of the cured layer. For example, the polymerizable unsaturated group is preferably an acryloyl group, a methacryloyl group, a vinyl group, a propenyl group, a butadienyl group, a styryl group, an ethynyl group, a cinnamoyl group, a maleate group, or an acrylamide group. The polymerizable unsaturated group-containing organic compound is preferably a compound having a silanol group in the molecule or a compound capable of undergoing hydrolysis to produce a silanol group. The polymerizable unsaturated group-containing organic compound also preferably has a photosensitive group.

The content of the inorganic oxide particles is preferably in the range of 100 to 200 parts by weight based on 100 parts by weight of the active energy ray-curable compound. When the content is 100 parts by weight or more, curling and folding can be more effectively prevented, and when the content is 200 parts by weight or less, a high level of scratch resistance or pencil hardness can be provided. The content is more preferably in the range of 100 to 150 parts by weight based on 100 parts by weight of the compound.

The photopolymerization initiator used has a 10% weight loss temperature of 170° C. or more as measured by a loss-on-heating test. The photopolymerization initiator preferably has a 10% weight loss temperature of 190° C. or more as measured by a loss-on-heating test. In other words, the physical properties of the photopolymerization initiator are preferably such that the weight loss (the rate of reduction in weight) on heating at 170° C. is 10% or less in a loss-on-heating test. The photopolymerization initiator more preferably shows a weight loss of 5%, even more preferably 2% or less, on heating at 170° C. in a loss-on-heating test.

When such a photopolymerization is used, the heat-treating step (2) is prevented from volatilizing the photopolymerization initiator from the surface of the cured layer, so that in the curing step (3), sufficient reactivity is obtained to form the cured layer, which makes it possible to impart a sufficient oligomer-migration preventing function to the cured layer. For example, the photopolymerization initiator to be used may be

2-hydroxy-1-{4-[4-(2-hydroxy-methyl-propionyl)benzyl]phenyl}-2-methyl-propane-1-one or
2-methyl-1-(4-methylthiophenyl)-2-morpholinopropane-1-one. To obtain sufficient reactivity in the curing step (3), the photopolymerization initiator is preferably used in an amount of 0.1 parts by weight or more based on 100 parts by weight of the active energy ray-curable compound. The photopolymerization initiator is more preferably used in an amount of 0.3 parts by weight or more, even more preferably 0.4 parts by weight or more. In view of a reduction in hardness, the photopolymerization initiator is preferably used in an amount of 10 parts by weight or less, more preferably 7 parts by weight or less.

A solvent capable of dissolving the active energy ray-curable compound and so on are selected and used to form the solution of the composition. Examples of solvents that may be used include various solvents such as ether solvents such as dibutyl ether, dimethoxymethane, dimethoxyethane, diethoxyethane, propylene oxide, 1,4-dioxane, 1,3-dioxolane, 1,3,5-trioxane, and tetrahydrofuran; ketone solvents such as acetone, methyl ethyl ketone, methyl isobutyl ketone, diethyl ketone, dipropyl ketone, diisobutyl ketone, cyclopentanone, cyclohexanone, methyl cyclohexanone, 2-octanone, 2-pentanone, 2-hexanone, 2-heptanone, and 3-heptanone; ester solvents such as ethyl formate, propyl formate, n-pentyl formate, methyl acetate, ethyl acetate, butyl acetate, n-pentyl acetate, methyl propionate, and ethyl propionate; acetylacetone solvents such as acetylacetone, diacetone alcohol, methyl acetoacetate, and ethyl acetoacetate; alcohol solvents such as methanol, ethanol, 1-propanol, 2-propanal, 1-butanol, 2-butanol, 1-pentanol, 2-methyl-2-butanol, and cyclohexanol; and glycol ether solvents such as ethylene glycol monoethyl ether acetate, ethylene glycol monoethyl ether, ethylene glycol monobutyl ether, ethylene glycol monomethyl ether, propylene glycol monomethyl ether acetate, and propylene glycol monomethyl ether. These solvents may be used alone or in combination of two or more. The concentration of the solution of the composition is generally from 1 to 60% by weight, preferably from 2 to 10% by weight.

To form the cured layer 11, first, the coating step (1) is performed which includes applying the solution composition to one or both sides of the first transparent resin film 10 to form a coating layer or layers on one or both sides of the first transparent resin film 10. The solution of the composition may be applied by a coating method such as roll coating such as reverse coating or gravure coating, spin coating, screen coating, fountain coating, dipping, or spraying. The coating layer is so formed that a cured layer 11 with a thickness of less than 1 μm can be finally obtained.

The heat-treating step (2) is then performed which includes removing the solvent from the coating layer by drying. The removal of the solvent by drying is performed under such controlled temperature conditions that the resulting first laminated film 1 has a thermal shrinkage of 0.5% or less when heated at 150° C. for 1 hour. In the heat-treating step (2), the solvent is removed by drying, and at the same time, thermal shrinkage is allowed to occur in advance for the resulting first laminated film 1, so that curling of the resulting first laminated film 1 is successfully reduced. The temperature of the heat-treating step (2) may be appropriately set depending on the type of the first transparent resin film 10 or the type of the solution composition used to form the cured layer 11. For example, the temperature of the heat-treating step (2) is preferably in the range of 125 to 165° C.

The curing step (3) is then performed which includes curing the coating layer having undergone the heat-treating step (2). Curing means may be selected from thermosetting or curing with active energy rays. In general, ultraviolet irradiation is preferably performed as the curing means. Ultraviolet irradiation can be performed using a high-pressure mercury lamp, a low-pressure mercury lamp, a halogen lamp, a xenon lamp, a metal halide lamp, or the like. Ultraviolet irradiation is preferably performed at an ultraviolet wavelength of 365 nm and a total dose of 50 to 500 mJ/cm². When the dose is 50 mJ/cm² or more, curing can be performed more sufficiently, so that the resulting cured layer 11 can have a more sufficient level of hardness. When the dose is 500 mJ/cm² or less, discoloration of the resulting cured layer 11 can be prevented.

If necessary, the first laminated film 1 may be provided with the functional layer (hard coating layer) 12. As described above, the cured layer 11 may be provided as an outermost layer on one side of the first transparent resin film 10, and the functional layer may be provided as another outermost layer on the other side of the first transparent resin film 10.

For example, a hard coating layer may be provided as the functional layer 12 (the functional layer other than the cured layer) to protect the outer surface. A cured film derived from curable resin such as melamine resin, urethane resin, alkyd resin, acrylic resin, or silicone resin is preferably used as a material to form the hard coating layer. The hard coating layer preferably has a thickness of 0.1 to 30 μm. Setting the thickness at 0.1 μm or more is preferred to provide hardness. If the thickness is more than 30 μm, the hard coating layer may be cracked, or curling may occur across the first laminated film 1.

An anti-glare layer or an anti-reflection layer may also be provided as the functional layer 12 to improve visibility. An anti-glare layer or an anti-reflection layer may be provided on the hard coating layer. The material used to form the anti-glare layer is typically, but not limited to, ionizing radiation-curable resin, thermosetting resin, thermoplastic resin, or the like. The anti-glare layer preferably has a thickness of 0.1 to 30 μm. The anti-reflection layer may be formed using titanium oxide, zirconium oxide, silicon oxide, magnesium fluoride, or the like. A plurality of anti-reflection layers may be provided.

The second laminated film 2 according to the invention can be formed by laminating a second heat-shrinkable transparent resin film 20 on the cured layer 11 of the first laminated film 1 with a pressure-sensitive adhesive layer 3 interposed therebetween.

The second transparent resin film 20 may be a heat-shrinkable resin film of the same type as the first transparent resin film 10. The second transparent resin film 20 may be made of the same material as the first transparent resin film 10. The second transparent resin film 20 may also be heat-treated in advance so that the first laminated film and the second transparent resin film can have substantially the same thermal shrinkage. The second transparent resin film 20 generally has a thickness of 10 to 200 μm, preferably 20 to 100 μm.

A transparent conductive layer 22 may be provided directly on one side of the second transparent resin film 20 opposite to the other side where the cured layer 11 is bonded, or provided on the one side of the second transparent resin film 20 with an undercoat layer interposed therebetween.

When the transparent conductive layer 22 is provided on the second transparent resin film 20 to form a transparent conductive film, the second transparent resin film 20 preferably has a thickness of 10 to 40 μm, more preferably 20 to 30 μm. If the thickness of the second transparent resin film 20 used to form a transparent conductive film is less than 10 μm, the mechanical strength of the second transparent resin film 20 may be insufficient, so that it may be difficult to perform the process of continuously forming the transparent conductive layer 22 on the second transparent resin film 20 being fed from a roll. If the thickness is more than 40 μm, the amount of introduction of the second transparent resin film 20 may decrease in the process of forming the transparent conductive layer 22, and the process of removing gas or moisture may be hindered, so that productivity may decrease. In this case, it may also be difficult to reduce the thickness of the transparent conductive laminated film.

The surface of the second transparent resin film 20 may be previously subject to sputtering, corona discharge treatment, flame treatment, ultraviolet irradiation, electron beam irradiation, chemical treatment, etching treatment such as oxidation, hard coating, or undercoating treatment such that the adhesion of the transparent conductive layer 22 or the undercoat layer 21 formed thereon to the second transparent resin film 20 can be improved. If necessary, the second transparent resin film 20 may also be subjected to dust removing or cleaning by solvent cleaning, ultrasonic cleaning or the like, before the transparent conductive layer 22 or the undercoat layer 21 is formed.

For example, materials that are preferably used to form the transparent conductive layer 22 include, but are not limited to, tin oxide-doped indium oxide, antimony-doped tin oxide, etc. When the above metal oxide is used to form the transparent conductive layer 22, the transparent conductive layer 22 can be made amorphous by controlling the content of tin oxide in the material (by adding tin oxide in a predetermined amount). When an amorphous transparent conductive layer is formed, the metal oxide preferably contains 90 to 99% by weight of indium oxide and 1 to 10% by weight of tin oxide. The metal oxide more preferably contains 95 to 98% by weight of indium oxide and 2 to 5% by weight of tin oxide. After the transparent conductive layer 22 is formed, if necessary, annealing may be performed in the range of 100 to 150° C. for crystallization.

Alternatively, the amorphous transparent conductive thin layer may be crystallized by a heat treatment as a crystallizing step (5) after the second laminated film of the invention is formed. The crystallization of the crystallizing step (5) may be performed using the same heating temperature (100 to 150° C.) as the annealing.

As used herein, the term “amorphous” means that when the surface of the transparent conductive thin layer is observed using a field emission transmission electron microscope (FE-TEM), the ratio of the area occupied by polygonal or elliptical crystals to the whole surface area of the transparent conductive thin layer is 50% or less (preferably 0 to 30%).

The thickness of the transparent conductive layer 22 is preferably, but not limited to, 10 nm or more, in order that it may form a highly-conductive continuous coating film with a surface resistance of 1×10³ Ω/square or less. If the thickness is too large, a reduction in transparency and so on may occur. Therefore, the thickness is preferably from 15 to 35 nm, more preferably from 20 to 30 nm. If the thickness is less than 15 nm, the surface electric resistance may be too high, and it may be difficult to form a continuous coating film. If the thickness is more than 35 nm, a reduction in transparency may occur.

The transparent conductive layer 22 may be formed using known conventional methods, while the methods are not particularly limited. Examples of such methods include vacuum deposition, sputtering, and ion plating. Any appropriate method may foe used depending on the required film thickness.

The undercoat layer 21 may be made of an inorganic material, an organic material or a mixture of an inorganic material and an organic material. The undercoat layer 21 may be formed of a single layer or two or more layers. When two or more layers are formed, any combination may be used.

Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on 100 parts by weight of the indium oxide may also be used.

The undercoat layer made of an inorganic material may be form with a dry process such as vacuum deposition, sputtering or ion plating, a wet process (coating process), or the like. SiO₂ is preferably used as the inorganic material to form the undercoat layer as described above. In a wet process, a silica sol or the like may be applied to form a SiO₂ film.

Examples of the organic material include acrylic resins, urethane resins, melamine resins, alkyd resins, siloxane polymers, and organosilane-based condensates. At least one of these organic materials may be used. In particular, a thermosetting resin including a mixture composed of a melamine resin, an alkyd resin and an organosilane condensate is preferably used as the organic material.

The thickness of the undercoat layer 21 is generally, but not limited to, from about 1 to about 300 nm, preferably from 5 to 300 nm, in view of optical design and the effect of preventing the release of an oligomer from the second transparent resin film 20. When two or more undercoat layers 21 are provided, the thickness of each layer may be from about 5 to about 250 nm, preferably from 10 to 250 nm.

Any transparent pressure-sensitive adhesive may be used for the pressure-sensitive adhesive layer 3 without limitation. For example, the pressure-sensitive adhesive may be appropriately selected from adhesives based on polymers such as acrylic polymers, silicone polymers, polyester, polyurethane, polyamide, polyvinyl ether, vinyl acetate-vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

The anchoring strength can be improved using an appropriate pressure-sensitive adhesive primer, depending on the type of the pressure-sensitive adhesive used to form the pressure-sensitive adhesive layer 3. Thus, when such a pressure-sensitive adhesive is used, a certain pressure-sensitive adhesive primer is preferably used. The pressure-sensitive adhesive primer is generally provided on the second transparent resin film 20 side.

The pressure-sensitive adhesive primer may be of any type capable of increasing the anchoring strength of the pressure-sensitive adhesive. Examples of the pressure-sensitive adhesive primer that may be used include what is called a coupling agent, such as a silane coupling agent having a hydrolyzable alkoxysilyl group and a reactive functional group such as an amino, vinyl, epoxy, mercapto, or chloro group in the same molecule, a titanate coupling agent having an organic functional group and a titanium-containing hydrolyzable hydrophilic group in the same molecule, and an aluminate coupling agent having an organic functional group and an aluminum-containing hydrolyzable hydrophilic group in the same molecule; and a resin having an organic reactive group, such as an epoxy resin, an isocyanate resin, a urethane resin, or an ester urethane resin. In particular, a silane coupling agent-containing layer is preferred, because it is easy to handle industrially.

The pressure-sensitive adhesive layer 3 may contain a cross linking agent depending on the base polymer. If necessary, the pressure-sensitive adhesive layer 3 may also contain appropriate additives such as natural or synthetic resins, glass fibers or beads, or fillers comprising metal powder or any other inorganic powder, pigments, colorants, and antioxidants. The pressure-sensitive adhesive layer 3 may also contain transparent fine particles so as to have light diffusing ability.

The transparent fine particles to be used may be one or more types of appropriate conductive inorganic fine particles of silica, calcium oxide, alumina, titania, zirconia, tin oxide, indium oxide, cadmium oxide, antimony oxide, or the like with an average particle size of 0.5 to 20 μm or one or more types of appropriate crosslinked or uncross linked organic fine particles of an appropriate polymer such as poly(methyl methacrylate) and polyurethane with an average particle size of 0.5 to 20 μm.

The pressure-sensitive adhesive layer 3 is generally formed using a pressure-sensitive adhesive solution (with a solids content of about 10 to about 50% by weight), in which a base polymer or a composition thereof is dissolved or dispersed in a solvent. An organic solvent such as toluene and ethyl acetate, water, or any other solvent may be appropriately selected depending on the type of the pressure-sensitive adhesive and used as the above solvent.

The method of forming pressure-sensitive adhesive layer 3 include, but are not limited to, a method including applying a pressure-sensitive adhesive (solution) and drying it, and a method including providing a pressure-sensitive adhesive layer on a release film and transferring it from the release film. The method of application may be roll coating such as reverse coating or gravure coating, spin coating, screen coating, fountain coating, dipping, or spraying.

The second transparent resin film 20 may be bonded to the cured layer 11 on the first transparent resin film 10 by a process including laminating the pressure-sensitive adhesive layer 3 on the second transparent resin film 20 and then bonding the cured layer 11 of the first laminated film 1 to the pressure-sensitive adhesive layer 3 or by a process including laminating the pressure-sensitive adhesive layer 3 on the cured layer 11 of the first laminated film 1 and then bonding the second transparent resin film 20 to the pressure-sensitive adhesive layer 3.

The second laminated film is obtained after the first laminated film is bonded to the second transparent resin film 20 (including the case of a transparent conductive film). In the second laminated film, the pressure-sensitive adhesive layer 3 has a cushion effect and thus can function to improve the scratch resistance of a transparent conductive layer 22 provided on one side of the second transparent resin film 20 and to improve the tap properties, specifically, the pen input durability and the contact pressure durability, of a touch panel-forming transparent conductive film. In terms of performing this function better, it is preferred that the elastic modulus of the pressure-sensitive adhesive layer 3 should be set in the range of 1 to 100 N/cm² and that its thickness should be set at 1 μm or more, generally in the range of 5 to 100 μm. With such a thickness, the effect is sufficiently produced, and a satisfactory adhesive strength is provided between the second transparent resin film 20 and the cured layer 11 of the first laminated film 1. If the thickness is less than the above range, the durability or the adhesion cannot be ensured sufficiently, and if the thickness is more than the above range, the appearance such as the transparency may be degraded.

If the elastic modulus is less than 1 N/cm², the pressure-sensitive adhesive layer 3 can be inelastic so that the pressure-sensitive adhesive layer 3 can easily deform by pressing to make the second transparent resin film 2 irregular and further to make the transparent conductive layer 22 irregular provided on the transparent conductive film 20. If the elastic modulus is less than 1 N/cm², the pressure-sensitive adhesive can easily squeeze out of the cut section, and the effect of improving the scratch resistance of the transparent conductive layer 22 or improving the tap properties of the transparent conductive layer 22 for touch panels can be reduced. If the elastic modulus is more than 100 N/cm², the pressure-sensitive adhesive layer 3 can be hard, and the cushion effect cannot be expected, so that the scratch resistance of the transparent conductive layer 22 or the pen input durability and surface contact pressure durability of the transparent conductive layer 22 for touch panels can tend to be difficult to improve.

If the thickness of the pressure-sensitive adhesive layer 3 is less than 1 μm, the cushion effect also cannot be expected so that the scratch resistance of the transparent conductive layer 22 or the pen input durability and surface contact pressure durability of the transparent conductive layer 22 for touch panels can tend to be difficult to improve. If it is too thick, it can reduce the transparency, or it can be difficult to obtain good results on the formation of the pressure-sensitive adhesive layer 3, the bonding workability of the cured layer 11 of the first laminated film 1 and the second transparent resin film 20, and the cost.

The laminated film 2(B) bonded through the pressure-sensitive adhesive layer 3 as described above imparts good mechanical strength and contributes to not only the pen input durability and the surface contact pressure durability but also the prevention of curling.

The pressure-sensitive adhesive 3 may be protected by a release film until it is subjected to the lamination. In such a case, for example, the release film to be used may be a laminate of a polyester film of a migration-preventing layer and/or a release layer, which is provided on a polyester film side to be bonded to the pressure-sensitive adhesive layer 3.

The total thickness of the release film is preferably 30 μm or more, more preferably in the range of 60 to 100 μm. This is to prevent deformation (dents) of the pressure-sensitive adhesive layer 3 in a case where the pressure-sensitive adhesive layer 3 is formed and then stored in the form of a roll, in which the deformation (dents) would be expected to occur due to foreign particles or the like intruding between portions of the rolled layer.

The migration-preventing layer may be made of an appropriate material for preventing migration of migrant components in the polyester film, particularly for preventing migration of low molecular weight oligomer components in the polyester. An inorganic or organic material or a composite thereof may be used to form the migration-preventing layer. The thickness of the migration-preventing layer may be set in the range of 0.01 to 20 μm as needed. The method of forming the migration-preventing layer, is not particularly limited, but for example, includes coating method, spraying method, spin coating method, or in-line coating method. Further, Vacuum deposition method, sputtering method, ion plating method, spray thermal decomposition method, chemical plating method, electroplating method, or the like may also be used.

The mold release layer may be made of an appropriate release agent such as a silicone-based mold release agent, a long-chain alkyl-based mold release agent, a fluorochemical-based mold release agent, or molybdenum sulfide. The thickness of the release layer may be set as appropriate in view of the release effect. In general, the thickness is preferably 20 μm or less, more preferably in the range of 0.01 to 10 μm, particularly preferably in the range of 0.1 to 5 μm, in view of handleability such as flexibility. The method of forming the release layer is not restricted, and the release layer may be formed using the same method as the method of forming the migration-preventing layer.

An ionizing radiation cured resin such as an acrylic resin, a urethane-based resin, a melamine-based resin, or an epoxy-based resin or a mixture of any of the above resins and aluminum oxide, silicon dioxide, mica, or the like may be used in the coating method, spraying method, spin coating method, or in-line coating method. Further, when the vacuum deposition method, sputtering method, ion plating method, spray thermal decomposition method, chemical plating method, or electroplating method is used, an oxide of a metal such as gold, silver, platinum, palladium, copper, aluminum, nickel, chromium, titanium, iron, cobalt, or tin, an oxide of an alloy thereof, or any other metal compounds such as metal iodides may be used.

### EXAMPLES

Hereinafter, the invention is more specifically described with reference to the examples, which however are not intended to limit the gist of the invention.

### Example 1

### Formation of Hard Coating Layer

A toluene solution for use as a hard coating layer-forming material was prepared by adding 5 parts by weight of 1-hydroxy-cyclohexyl-phenyl ketone (Irgacure 184 manufactured by Cuba Specialty Chemicals Inc.) as a photopolymerization initiator to 100 parts by weight of an acrylic urethane resin (UNIDIC 17-806 manufactured by DIC Corporation) and diluting the mixture with toluene to a concentration of 30% by weight.

The hard coating layer-forming material was applied to one side of a 125 μm thick polyethylene terephthalate film as a first transparent resin film and dried at 100° C. for 3 minutes. The coating was then irradiated with ultraviolet light from a high-pressure mercury lamp at a total dose of 300 mJ/cm² to form a 7 μm thick hard coating layer.

### Preparation of First Laminated Film: Formation of Cured layer

Provided was a mixture (OPSTAR Z7540 (trade name) manufactured by JSR Corporation, solids content: 56% by weight, solvent: butyl acetate/methyl ethyl ketone (MEK)=76/24(volume ratio), refractive index: 1.49) for a cured layer-forming material. The mixture for a cured layer-forming material contains active energy ray-curable compounds and silica nanoparticles dispersed therein, in which the silica nanoparticles are composed of inorganic oxide particles and a polymerizable unsaturated group-containing organic compound bonded to the inorganic oxide particles. The mixture for a cured layer-forming material contains dipentaerythritol and isophorone diisocyanate-based polyurethane as active energy ray-curable compounds, and silica fine particles (at most 100 nm in weight average particle size) whose surface is modified with an organic molecule, in which the weight ratio of the active energy ray-curable compounds to the particles is 2:3. Five parts by weight of 2-methyl-1-(4-methylthiophenyl)-2-morpholinopropane-1-one as a photopolymerization initiator (Irgacure 907 manufactured by Ciba Specialty Chemicals Inc., which has a 10% weight loss temperature of 202° C. as measured by the loss-on-heating test) was added to the mixture for a cured layer-forming material based on 100 parts by weight of the solids of the active energy ray-curable compounds. The resulting mixture was diluted with butyl acetate and methyl ethyl ketone (2:1 in weight ratio) to a solid concentration of 10% by weight, so that a cured layer-forming material was obtained.

Using a comma coater, the cured layer-forming material was applied to the surface of the first transparent resin film opposite to its surface where the hard coating layer was formed, so that a coating layer was formed. The coating layer was then dried by heating at 145° C. for 1 minute. Subsequently, the coating layer was irradiated with ultraviolet light from a high-pressure mercury lamp at a total dose of 300 mJ/cm² to form a 300 nm thick cured layer, so that a hard coating layer carrying first laminated film was obtained.

### Preparation of Transparent Conductive Film

In a 0.4 Pa atmosphere composed of 80% argon gas and 20% oxygen gas, a 22 nm thick ITO layer was formed on one surface of a 25 μm thick polyethylene terephthalate film as a second transparent resin film by a reactive sputtering method using a sintered material of 97% by weight of indium oxide and 3% by weight of tin oxide under the conditions of a polyethylene terephthalate film temperature of 100° C. and a discharge power of 6.35 W/cm², so that a transparent conductive film was obtained. The ITO layer was amorphous.

### Preparation of Second Laminated Film

A pressure-sensitive adhesive layer was formed on the cured layer of the first laminated film, and a second laminated film was prepared by bonding the pressure-sensitive adhesive layer to the surface of the transparent conductive film opposite to its surface where the transparent conductive layer was formed. The pressure-sensitive adhesive layer formed was a 25 μm thick transparent acrylic pressure-sensitive adhesive layer (1.47 in refractive index) with an elastic modulus of 10 N/cm². The composition used to form the pressure-sensitive adhesive layer was a mixture containing 100 parts by weight of an acryl-based copolymer of butyl acrylate, acrylic acid, and vinyl acetate (100:2:5 in weight ratio) and 1 part by weight of an isocyanate crosslinking agent.

The resulting transparent conductive laminated film was heat-treated at 140° C. for 90 minutes so that the amorphous ITO layer was crystallized.

### Example 2

A second laminated film was obtained as in Example 1, except that

2-hydroxy-1-{4-[4-(2-hydroxy-methyl-propionyl)benzyl]phenyl}-2-methyl-propane-1-one (Irgacure 127 manufactured by Ciba Specialty Chemicals Inc., which has a 10% weight loss temperature of 263° C. as measured by the loss-on-heating test) was used as the photopolymerization initiator in the process of preparing the first laminated film (in the process of forming the cured layer). Crystallization was also performed as In Example 1.

### Comparative Example 1

A second laminated film was obtained as in Example 1, except that 1-hydroxy-cyclohexyl-phenyl ketone (Irgacure 184 manufactured by Ciba Specialty Chemicals Inc., which has a 10% weight loss temperature of 154° C. as measured by the loss-on-heating test) was used as the photopolymerization initiator in the process of preparing the first laminated film (in the process of forming the cured layer). Crystallization was also performed as in Example 1.

### Reference Example 1

A second laminated film was obtained as in Example 1, except that 1-hydroxy-cyclohexyl-phenyl ketone (Irgacure 184 manufactured by Ciba Specialty Chemicals Inc., which has a 10% weight loss temperature of 154° C. as measured by the loss-on-heating test) was used as the photopolymerization initiator in the process of preparing the first laminated film (in the process of forming the cured layer), the coating layer-drying temperature was changed to 80° C., and a heat treatment at 150° C. for 1 minute was further performed after the ultraviolet irradiation. Crystallization was also performed as in Example 1.

The first laminated film and the crystallized second laminated film (transparent conductive laminated film) obtained in each of the examples and the comparative examples were evaluated as described below. Table 1 shows the results. Table 1 also shows the weight loss on heating of the photopolymerization initiator and the thermal shrinkage of the first laminated film (upon heating at 150° C. for 1 hour), which were evaluated by the methods described below.

### Loss-On-Heating Test

Before the test, the sample (photopolymerization initiator) was subjected to a pre-treatment at 100° C. for 5 minutes for removing volatile impurities such as water. About 10 mg of the sample (photopolymerization initiator) was then placed in a thermogravimetric analyzer (Tg/DTA6200 manufactured by Seiko Instruments Inc.) and heat-treated at a rate of temperature rise of 5° C./minute in a nitrogen gas stream, when the temperature at which the weight loss M (%) on heating calculated from the formula below reached 10% was determined. The weight loss M (%) on heating at 170° C. was calculated from the formula below using the weight of the sample measured at 170° C.

M0 is the weight of the sample before the heat treatment, and M1 is the weight of the sample after the heat treatment.

M(%)=[(M0−M1)/M0]×100

### Thermal Shrinkage

The hard coating layer carrying first laminated film was cut into a 10 cm square piece. The size of the piece in the initial state (the initial size) was measured, and the size of the piece after a heat treatment at 150° C. for 1 hour (the size after heating) was then measured. Using these measured values, the thermal shrinkage in each of the MD (machine direction) and the TD (transverse direction) was calculated from the formula below.

Thermal shrinkage(%)={(the initial size−the size after heating)/the initial size}×100

### Scratch Resistance of Cured Layer Surface

The surface of the cured layer was rubbed 10 times over a length of 10 cm with steel wool under a load of 250 g/25 mmφ. The surface state of the cured layer was then visually observed and evaluated according to the criteria below.

O: Thin scratches are observed over the surface.

x: Significant scratches are observed over the surface.

### Curling

The crystallized second laminated film was cut into a 10 cm square piece. The piece was placed on a horizontal surface with its convexly curled surface facing downward. The longest distance (mm) among the distances from the horizontal surface to the four corners was measured. The case where the piece is concavely curled with its ITO-side surface facing upward is expressed as plus (+), and the case where the piece is concavely curled with its hard coating layer-side surface facing upward is expressed as minus (−).

TABLE 1

| | Formation of cured layer | | | | | | | | |
|---|---|---|---|---|---|---|---|---|---|
| | Photopolymerization initiator | | | | | Evaluation | | | |
| | | 10% weight loss | Weight | | Heat | First laminated film | | | Second |
| | | temperature (° C.) | loss | Coating | treatment | Thermal | | Scratch | laminated |
| | | measured by | (%) on | layer-drying | temperature | shrinkage | | resistance | film |
| | | loss-on-heating | heating at | temperature | (° C.) after | (%) | | of cured | Curling |
| | Type | test | 170° C. | (° C.) | curing step | MD | TD | layer | (mm) |
| Example 1 | Irgacure | 202° C. | 2.0% | 145 | Absent | 0.40 | 0.03 | ∘ | 0 |
| | 907 | | | | | | | | |
| Example 1 | Irgacure | 263° C. | 0.3% | 145 | Absent | 0.38 | 0.05 | ∘ | 0 |
| | 127 | | | | | | | | |
| Comparative | Irgacure | 154° C. | 21.8% | 145 | Absent | 0.38 | 0.07 | x | 0 |
| Example 1 | 184 | | | | | | | | |
| Reference | Irgacure | 154° C. | 21.8% | 80 | 145 | 0.39 | 0.03 | ∘ | 0 |
| Example 1 | 184 | | | | | | | | |

As shown in Table 1, the first laminated film of each example has a cured layer with good scratch resistance, and causes no curling even when used to form the second laminated film. In contrast, the cured layer of Comparative Example 1 does not have a satisfactory level of scratch resistance as a result of the high-temperature heat treatment of the thin coating layer, because the photopolymerization initiator used in the cured layer-forming material does not satisfy the loss-on-heating requirement according to the invention. In Reference Example 1, the cured layer has good scratch resistance, and curling is not observed even when the second laminated film is formed. However, Reference Example 1 is not advantageous for production because an additional heat treatment is performed after the cured layer is formed.

### DESCRIPTION OF REFERENCE SIGNS

1 First Laminated Film
10 First Transparent Resin Film
11 Cured Layer
12 Functional Layer (Hard Coating Layer)
2 Second Laminated Film
20 Second Transparent Resin Film
21 Undercoat Layer
22 Transparent Conductive Layer
3 Pressure-Sensitive Adhesive Layer

1. A method for producing a first laminated film, comprising:
forming a cured layer or layers on one or both sides of a first heat-shrinkable transparent resin film,
wherein the first laminated film is for use in forming a second laminated film by laminating a second heat-shrinkable transparent resin film on the cured layer of the first laminated film with a pressure-sensitive adhesive layer interposed therebetween,
the cured layer has a thickness of less than 1 μm, and
the cured layer is formed by a process comprising:
a coating step (1) applying a solution composition to one or both sides of the first transparent resin film to form a coating layer or layers, wherein the solution composition contains an active energy ray-curable compound, a photopolymerization initiator, and a solvent, wherein the photopolymerization initiator has a 10% weight loss temperature of 170° C. or more as measured by a loss-on-heating test;
a heat-treating step (2) removing, after the coating step (1), a solvent from the coating layer or layers by drying under such temperature conditions that the first laminated film obtained has a thermal shrinkage of 0.5% or less when heated at 150° C. for 1 hour, and
a curing step (3) curing the coating layer or layers after the heat-treating step (2).

2. The method for producing a first laminated film according to claim 1, wherein the photopolymerization initiator is 2-hydroxy-1-{4-[4-(2-hydroxy-methyl-propionyl)benzyl]phenyl}-2-methyl-propane-1-one and/or 2-methyl-1-(4-methylthiophenyl)-2-morpholinopropane-1-one.

3. The method for producing a first laminated film according to claim 1, wherein the photopolymerization initiator is used in an amount of 0.1 parts by weight or more based on 100 parts by weight of the active energy ray-curable compound.

4. The method for producing a first laminated film according to claim 1, wherein the heat-treating step (2) is performed at a temperature of 125 to 165° C.

5. The method for producing a first laminated film according to claim 1, wherein the first laminated film has the cured layer as an outermost layer on one side and has a functional layer as another outermost layer on another side.

6. The method for producing a first laminated film according to claim 5, wherein the functional layer is a hard coating layer.

7. A method for producing a second laminated film, comprising:
producing the first laminated film by the method according to claim 1; and
then performing a laminating step (4) bonding a second heat-shrinkable transparent resin film to the cured layer of the first laminated film with a pressure-sensitive adhesive layer interposed therebetween.

8. The method for producing a second laminated film according to claim 7, wherein a transparent conductive layer is provided, directly with an undercoat layer interposed therebetween, on one side of the second transparent resin film opposite to the second transparent resin film side where the cured layer is to be bonded.

9. The method for producing a second laminated film according to claim 7, wherein the transparent conductive layer is an amorphous transparent conductive layer made of a metal oxide, the method further comprising a crystallizing step (5) crystallizing the amorphous transparent conductive layer by heating after the laminating step (4).
